(19) United States
(12) Patent Application Publication
(10) Pub. No.: US 2021/0017790 A1
(43) Pub. Date: Jan. 21, 2021

(54) EMERGENCY DOOR LATCH REMOVER

(71) Applicant: David Hanley, Huntington Beach, CA (US)

(72) Inventor: David Hanley, Huntington Beach, CA (US)

(21) Appl. No.: 16/513,965

(22) Filed: Jul. 17, 2019

(51) Int. Cl. E05B 19/20

(52) U.S. Cl. CPC E05B 19/20

(57) ABSTRACT

An illustrated door latch tool for externally unlatching a door latch. The door latch tool is useful when an emergency or other event occurs that requires entry into a room that has the door barred by the door latch. This door latch tool is useful for police officers, security officials, hotels, parents, etc. when there is a need to render aid to a person in the room or to aid in removing the person from the room and from any potential danger. The door latch tool has a card and a holder. When an event occurs and the door has a door latch locking the door, then the door is opened to its further point. The door latch tool is placed inside an opening of the door at the height of the door latch. The holder is held to maintain the placement of the door latch tool. The door is closed, thus the door latch tool aides in releasing the door latch such that the door may now be opened.

### FIELD OF THE INVENTION

This invention relates to door latches. More particularly, it relates to disengagement of door latches.

### BACKGROUND

A lock is a mechanical or electronic fastening device that is released by a physical object (such as a key, keycard, fingerprint, RFID card, security token, coin etc.), by supplying secret information (such as a number or letter permutation or password), or by a combination thereof.

A key is a device that is used to operate a lock (such as to lock or unlock it). A typical key is a small piece of metal consisting of two parts: the bit or blade, which slides into the keyway of the lock and distinguishes between different keys, and the bow, which is left protruding so that torque can be applied by the user. In its simplest implementation, a key operates one lock or set of locks that are keyed alike, a lock/key system where each similarly keyed lock requires the same, unique key.

The key serves as a security token for access to the locked area; only persons having the correct key can open the lock and gain access. In more complex mechanical lock/key systems, two different keys, one of which is known as the master key, serve to open the lock. Common metals include brass, plated brass, nickel ver, and steel.

A latch or catch (called sneck in Northern England and Scotland) is a type of mechanical fastener that joins two (or more) objects or surfaces while allowing for their regular separation. A latch typically engages another piece of hardware on the other mounting surface. Depending upon the type and design of the latch, this engaged bit of hardware may be known as a keeper or strike.

A latch is not the same as the locking mechanism of a door or window, although often they are found together in the same product.

Latches range in complexity from flexible one-piece flat springs of metal or plastic, such as are used to keep blow molded plastic power tool cases closed, to multi-point cammed latches used to keep large doors closed.

A night latch (or night-latch or nightlatch) is a door lock having a sprung bolt that is operated from the exterior side of the door by a key and from the interior (i.e. “secure”) side of the door by a knob.

Night latches are usually rim locks. A rim lock is a locking device that attaches to the surface of a door.

Historically, such locks were intended for use at night-time, hence the name. The keyless egress that they offer is a valuable fire safety measure.

In the case of an emergency, the night latch is nearly impossible to access from the exterior of the room. There may be people inside the room unable to remove the night-latch for a variety of reasons, or may not be aware of an emergency such as a fire in the building. Therefore, in light of at least the issues described above, there is a need for a device to allow for the removal of a night latch from the exterior of the room.

### BRIEF DESCRIPTION OF THE DRAWINGS

FIG. 1 is an illustrated view of an exemplary door latch tool.

FIG. 2 is a flowchart for utilizing the exemplary door latch shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

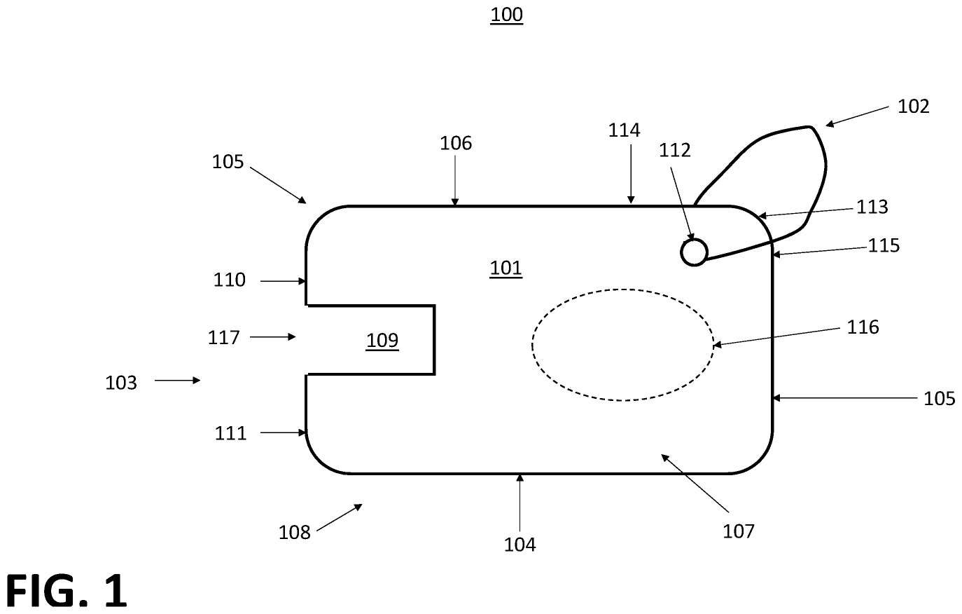

Referring to FIG. 1, an illustrated door latch tool 100 for externally unlatching a door latch. The door latch tool 100 is useful when an emergency or other event occurs that requires entry into a room that has the door barred by the door latch. This door latch tool 100 is useful for police officers, security officials, hotels, parents, etc. when there is a need to render aid to a person in the room or to aid in removing the person from the room and from any potential danger.

The door latch tool 100 has a card 101 and a holder 102. The door latch tool 100 is preferably transportable, thereby being portable. The holder 102 is preferably a lanyard, but other types of holders are hereby contemplated including, but not limited to, rope, string, etc. The holder 102 is preferably made of a vinyl material, but other materials are hereby contemplated including, but not limited to, cotton, plastic, etc.

The card 101 is preferably made of a steel material, but other types of materials are hereby contemplated including, but not limited to, aluminum, wood, hard-plastic, etc. The card 101 is preferably two (2) inches in height, but other heights are hereby contemplated including but not limited to, one (1) inch, three (3) inches, four (4) inches, etc. The card 101 preferably has a length of three and one-half (3.5) inches, but other lengths are hereby contemplated including, but not limited to, three (3) inches, four (4) inches, six (6) inches, etc. The card 101 preferably has a depth of twenty-eight (28) gauge, but other depths are hereby contemplated including, but not limited to, twenty-four (24) gauge, thirty (30) gauge, etc. The width of the card 101 should not be greater than a gap between a door and a door frame.

The card 101 of the door latch tool 100 has a first side 103, a second side 104, a third side 105, a fourth side 106, a top 107 and a bottom 108. The bottom 108 of the card 101 is preferably flat, but may be concave, convex, etc. The top 107 of the card 101 is preferably flat, but may be concave, convex, etc.

The first end 103 of the card 101 has an opening 109. The opening 109 is substantially near a mid-point 117 between a first end 110 of the card 101 and a second end 111 of the card 101. The opening 109 is preferably one and one-half (1.5) inch in height, but other heights are hereby contemplated including, but not limited to, one (1) inch, one and one-fourth (1.25) inches, one and three-fourths (1.75) inches, etc. The opening is preferably one (1) inch in length, but other lengths are hereby contemplated including, but not limited to, one-half (0.5) inch, one and one-half (1.5) inches, two (2) inches, etc.

A hole 112 at substantially near a corner 113 defined at the first end 114 of the fourth side 106 intersecting with the first end 115 of the third side 105. The hole 112 may have a lining, such that the holder 102 does not become frayed or damaged by contact with the hole 112. The hole 112 of the card 101 receives the holder 102 of the door latch tool 100.

Optionally and/or additionally, the top 107 of the card 101 of the door latch tool 100 may have a logo or name area 116. The area 116 is preferably a logo, but other types of entries are hereby contemplated including, but not limited to, name, pattern, art work, etc.

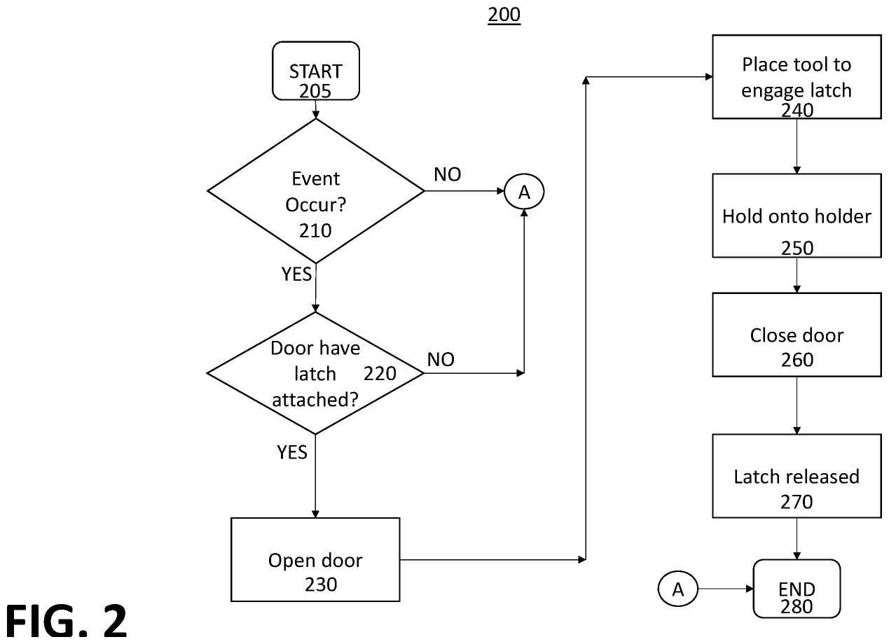

Moving now to FIG. 2, a flowchart 200 is presented to show the method of use of the door latch tool 100.

The flowchart 200 begins at the start 205. It is determined at 210 whether there has been an event. The event would be either an emergency or some other happening that would require the need to enter a locked room to either retrieve the person in the room or to have the person taken into custody by a police officer.

If no such event has occurred, the flowchart 200 is then ended at the END at 280. If an event has occurred, at 220 it is determined if the door is locked by a door latch. If door is locked by other means than a door latch, the flowchart 200 is ended at 280, the END.

If the door determined by be locked by a door latch at 230, then at 240 the door is opened as far as possible thus stretching the door latch to it furthest extent.

Once the door has been opened as far as possible at 240, the door latch tool 100 is placed inside a gap created by the opening of the door as far as possible. The door latch tool 100 is placed at a level consistent with a positioning of the door latch.

At 250, the holder 102 is held to keep the door latch tool 100 in place. Once the holder 102 is secured, at 260 the door is closed. When at 260 the door has been closed, then at 270 the latch is released by the door latch tool 100. The door latch tool 100 can then be removed by pulling on the holder 102 and sliding it from the gap between the door and the door frame. The door can now be opened for access to the room. The process ends at 280 the END.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A door latch tool for unlatching a closed door, the tool comprising:
a card, the card comprising:
a first side, the first side having a first end, a second end and a mid-point;
an opening, the opening being at substantially the mid-point of the first side between the first end of the first side and the second end of the first side; and
a hole, the hole being substantially near a corner, wherein the corner being substantially near the corner of a first end of a fourth side and a first end of a third side;
a holder, the holder being coupled to the hole of the card.

2. The tool of claim 1, wherein the card being two (2) inches in height.

3. The tool of claim 1, wherein the card being three and one-half (3.5) inches in length.

4. The card of claim 1, wherein the card having a depth of 28 gauge.

5. The tool of claim 1, wherein the opening having a height of one and one-half (1.5) inches.

6. The tool of claim 1, wherein the opening having a length of one (1) inch.

7. The tool of claim 1, wherein the card being made of a steel material.

8. The tool of claim 1, wherein the holder being a lanyard.

9. The tool of claim 1, wherein the lanyard being made of a vinyl material.

10. The tool of claim 1, wherein the hole being lined.

11. A method of unlatching a latched door, the method comprising:
determining that an event has occurred;
determining that a door has a door latch, the door latch securing the door in a closed position;
opening the door to a furthest opening;
Inserting a door latch tool into the opening, the door latch tool being significantly at the level of the door latch;
holding the holder; and
closing the door, wherein the door latch is released and wherein the door being openable.

12. The method of claim 11, wherein the card being two (2) inches in height.

13. The method of claim 11, wherein the card being three and one-half (3.5) inches in length.

14. The method of claim 11, wherein the card having a depth of 28 gauge.

15. The method of claim 11, wherein the opening having a height of one and one-half (1.5) inches.

16. The method of claim 11, wherein the opening having a length of one (1) inch.

17. The method of claim 11, wherein the card being made of a steel material.

18. The method of claim 11, wherein the holder being a lanyard.

19. The method of claim 11, wherein the lanyard being made of a vinyl material.

20. The method of claim 11, wherein the hole being lined.
